(19) United States
(12) Patent Application Publication
(10) Pub. No.: US 2022/0398376 A1
(43) Pub. Date: Dec. 15, 2022

(54) INFORMATION PROCESSING APPARATUS, NON-TRANSITORY COMPUTER READABLE MEDIUM STORING PROGRAM, AND INFORMATION PROCESSING METHOD

(71) Applicant: FUJIFILM Business Innovation Corp., Tokyo (JP)

(72) Inventor: Minoru SODEURA, Kanagawa (JP)

(73) Assignee: FUJIFILM Business Innovation Corp., Tokyo (JP)

(21) Appl. No.: 17/542,478

(22) Filed: Dec. 5, 2021

(30) Foreign Application Priority Data
Jun. 10, 2021 (JP) 2021-097568

(51) Int. Cl. G06F 40/174; G06V 30/412; G06F 3/0482

(52) U.S. Cl. CPC G06F 40/174; G06V 30/412; G06F 3/0482; G06F 2203/04803

(57) ABSTRACT

An information processing apparatus includes a processor configured to specify plural types which are candidates of a type of data, perform a control for displaying the plural types after acquiring an attribute with respect to at least one type of the specified plural types from the data, and perform a control for displaying the attribute acquired from the data with respect to a first type in accordance with an operation of selecting the first type from the displayed plural types by a user.

### CROSS-REFERENCE TO RELATED APPLICATIONS

This application is based on and claims priority under 35 USC 119 from Japanese Patent Application No. 2021-097568 filed Jun. 10, 2021.

### BACKGROUND

### (i) Technical Field

The present invention relates to an information processing apparatus, a non-transitory computer readable medium storing a program, and an information processing method.

### (ii) RELATED ART

JP4630350B discloses an image processing apparatus that receives a plurality of images, stores the plurality of images, and performs image processing. The image processing apparatus includes an identification unit that reads business form type information by identifying a code embedded in a ruled line provided at a position defining a handwriting input position of a user and divides the plurality of images into any of a first image or a second image based on the business form type information, an image recognition unit that recognizes information related to the second image from the first image, a processing setting unit that sets processing of the second image based on recognition of the image recognition unit, and an image processing unit that performs the processing of the second image based on setting of the processing setting unit.

### SUMMARY

There is a system that specifies and displays a type of data and, in a case where a user operation of correcting the displayed type of data is performed, acquires an attribute with respect to the corrected type from the data and displays the attribute. In this system, since the attribute with respect to the corrected type is acquired from the data only after the user operation of correcting the displayed type of data is performed, displaying the attribute of the data with respect to the corrected type takes time.

Aspects of non-limiting embodiments of the present disclosure relate to an information processing apparatus, a non-transitory computer readable medium storing a program, and an information processing method that shorten a time period from performing a user operation of correcting a displayed type of data until displaying an attribute of the data for the corrected type.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing apparatus including a processor configured to specify a plurality of types which are candidates of a type of data, perform a control for displaying the plurality of types after acquiring an attribute with respect to at least one type of the plurality of specified types from the data, and perform a control for displaying the attribute acquired from the data with respect to a first type in accordance with an operation of selecting the first type from the plurality of displayed types by a user.

### BRIEF DESCRIPTION OF THE DRAWINGS

Exemplary embodiment(s) of the present invention will be described in detail based on the following figures, wherein:

FIG. 1 is a diagram illustrating an overall configuration example of a business form processing system in an exemplary embodiment of the present invention;

FIG. 2 is a diagram illustrating a hardware configuration example of a business form processing apparatus in the exemplary embodiment of the present invention;

FIG. 3 is a block diagram illustrating a functional configuration example of the business form processing apparatus in the exemplary embodiment of the present invention;

FIGS. 4A and 4B are diagrams for describing attribute information stored in an attribute information storage unit;

FIG. 5 is a flowchart illustrating an operation example in a case where the business form processing apparatus in the exemplary embodiment of the present invention initially displays a business form type and an attribute;

FIG. 6 is a flowchart illustrating an operation example after the business form processing apparatus in the exemplary embodiment of the present invention initially displays the business form type and the attribute;

FIG. 7 is an example of an attribute registration screen for registering an attribute of a business form displayed on a display device by the business form processing apparatus in a task management apparatus; and

FIG. 8 is an example of the attribute registration screen for registering the attribute of the business form displayed on the display device by the business form processing apparatus in the task management apparatus.

### DETAILED DESCRIPTION

Hereinafter, an exemplary embodiment of the present invention will be described in detail with reference to the accompanying drawings.

Summary of Present Exemplary Embodiment

The present exemplary embodiment provides an information processing apparatus that specifies a plurality of types which are candidates of a type of data, performs a control for displaying the plurality of types after acquiring an attribute with respect to at least one type of the plurality of specified types from the data, and performs a control for displaying the attribute acquired from the data with respect to a first type in accordance with an operation of selecting the first type from the plurality of displayed types by a user.

Here, the data may be any data of a defined type from which an attribute can be acquired. Hereinafter, a business form image obtained by scanning a business form using an image scanning apparatus will be illustratively described as the data. The type of data is a reference in a case where the data can be distinguished by any reference. The attribute of the data is a property of the data or information set in the data.

In addition, the plurality of types which are the candidates of the type of data may be specified using any of the following methods. A first method is a method of distinctively specifying a second type having a high probability of being the type of data and one or more types of which a degree of similarity to the second type is greater than or equal to the reference. A second method is a method of specifying the plurality of types without distinction based on whether or not the data satisfies a predetermined condition related to a feature of each type. Hereinafter, a case of employing the first method as a method of specifying the plurality of types will be illustratively described.

Furthermore, the information processing apparatus may be the image scanning apparatus that scans the business form. Hereinafter, a business form processing apparatus that is connected to the image scanning apparatus and processes the business form image will be illustratively described as the information processing apparatus.

Overall Configuration of Business Form Processing System

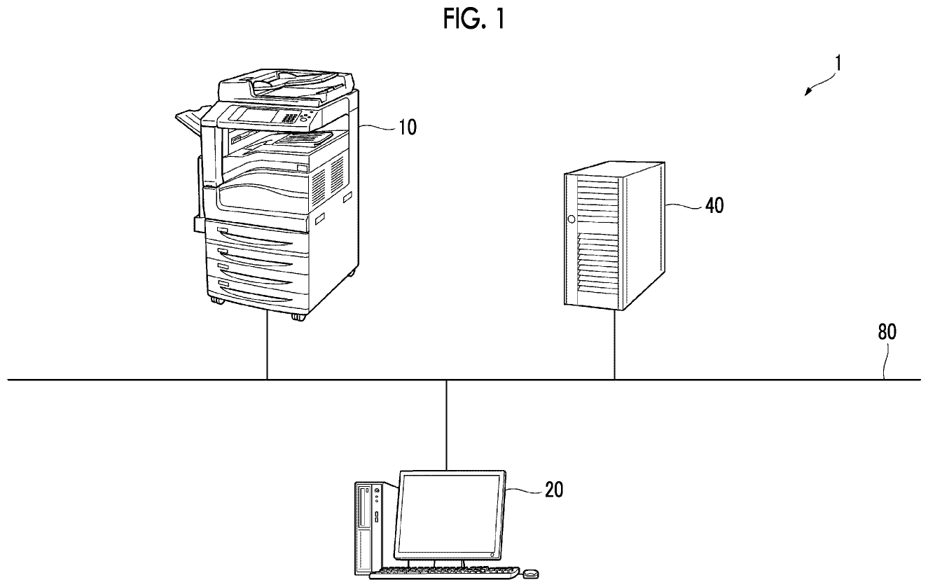

FIG. 1 is a diagram illustrating an overall configuration example of a business form processing system 1 in the present exemplary embodiment. As illustrated in FIG. 1, the business form processing system 1 is configured by connecting an image scanning apparatus 10, a business form processing apparatus 20, and a task management apparatus 40 to a communication line 80. While only one image scanning apparatus 10, one business form processing apparatus 20, and one task management apparatus 40 are illustrated in FIG. 1, two or more of each apparatus may be disposed.

The image scanning apparatus 10 is an apparatus that performs image scanning from a recording medium such as paper. The image scanning apparatus 10 may use, as an image scanning method, for example, a charge coupled devices (CCD) method of reducing, using a lens, reflected light with respect to light with which an original document is irradiated from a light source, and receiving the reflected light using a CCD. Alternatively, the image scanning apparatus 10 may use, as the image scanning method, a contact image sensor (CIS) method of receiving reflected light with respect to light with which the original document is sequentially irradiated from an LED light source, using a CIS. In addition, the image scanning apparatus 10 may perform image formation on the paper and image transmission, image reception, and the like through a public line.

The business form processing apparatus 20 is an apparatus that processes the business form image obtained by performing the image scanning of the business form using the image scanning apparatus 10. Specifically, the business form processing apparatus 20 determines the business form type that is the type of business form, based on the business form image and extracts the attribute from the business form image in accordance with a determination result of the business form type. In a case where the extracted attribute is incorrect, the business form processing apparatus 20 corrects the extracted attribute to a correct attribute and then, uploads the correct attribute to, for example, the task management apparatus 40. For example, the business form processing apparatus 20 may be a general-purpose personal computer.

The task management apparatus 40 is an apparatus that manages various tasks such as customer management, sale, and the like using the attribute of the business form uploaded by the business form processing apparatus 20. For example, the task management apparatus 40 may be a cloud server. In a case where the attribute extracted by the business form processing apparatus 20 is used within only the business form processing apparatus 20, the task management apparatus 40 may not be disposed.

The communication line 80 is a line used for information communication between the image scanning apparatus 10 and the business form processing apparatus 20 and between the business form processing apparatus 20 and the task management apparatus 40. For example, a local area network (LAN) or the Internet may be used as the communication line 80.

Hardware Configuration of Business Form Processing Apparatus

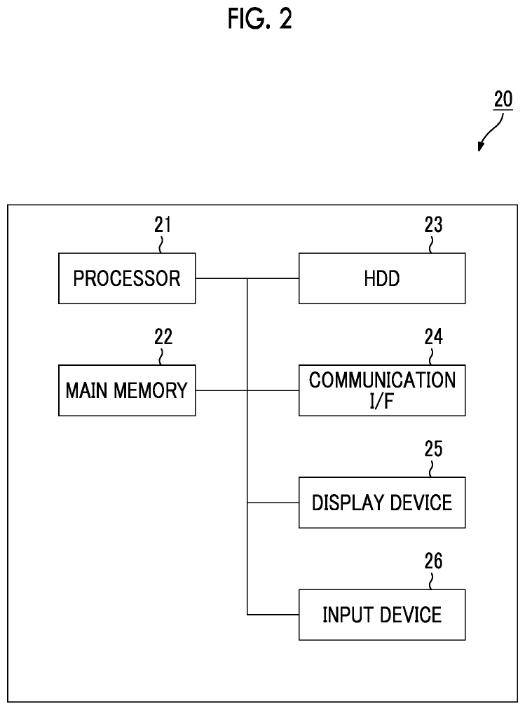

FIG. 2 is a diagram illustrating a hardware configuration example of the business form processing apparatus 20 in the present exemplary embodiment. As illustrated in FIG. 2, the business form processing apparatus 20 includes a processor 21, a main memory 22, and a hard disk drive (HDD) 23. Here, the processor 21 implements each function described later by executing various software such as an operating system (OS) and applications. In addition, the main memory 22 is a storage region storing the various software, data used for execution of the various software, and the like. The HDD 23 is a storage region storing input data for the various software, output data from the various software, and the like. Furthermore, the business form processing apparatus 20 includes a communication interface (hereinafter, referred to as the “I/F”) 24 for external communication, a display device 25 such as a display, and an input device 26 such as a keyboard or a mouse.

Functional Configuration of Business Form Processing Apparatus

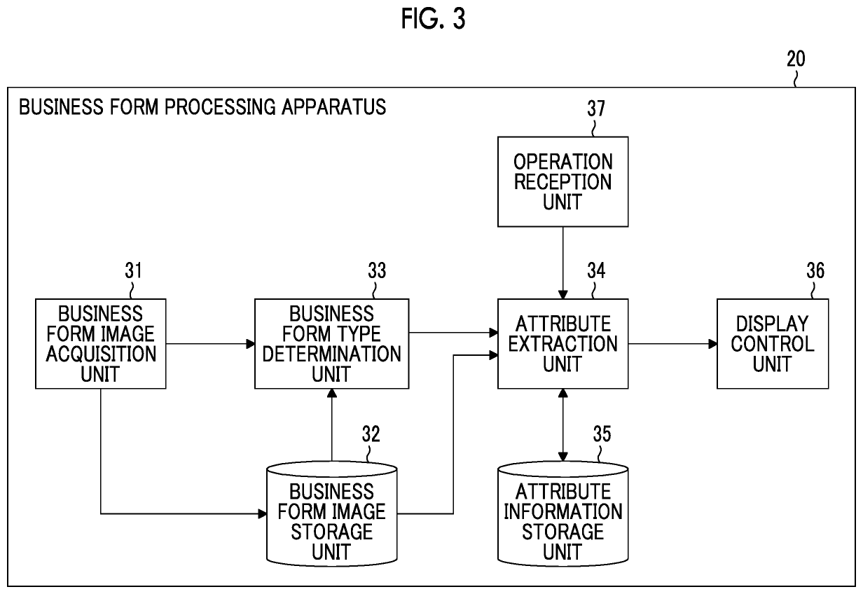

FIG. 3 is a block diagram illustrating a functional configuration example of the business form processing apparatus 20 in the present exemplary embodiment. As illustrated in FIG. 3, the business form processing apparatus 20 includes a business form image acquisition unit 31, a business form image storage unit 32, a business form type determination unit 33, an attribute extraction unit 34, an attribute information storage unit 35, a display control unit 36, and an operation reception unit 37.

The business form image acquisition unit 31 acquires the business form image scanned by the image scanning apparatus 10. In the present exemplary embodiment, the business form image is used as an example of the data and an example of business form data.

The business form image storage unit 32 stores the business form image acquired by the business form image acquisition unit 31.

In a case where the business form image acquisition unit 31 stores the business form image in the business form image storage unit 32, the business form type determination unit 33 reads the business form image from the business form image storage unit 32 and determines the business form type of the business form that is a base of the business form image. The business form type determination unit 33 may determine, for example, the business form type having the highest probability of being the type of business form as a determination business form type. Hereinafter, this determination business form type will be referred to as the “determination business form type”. In addition, the business form type determination unit 33 specifies business form types similar to the determination business form type. Here, “similar to the determination business form type” is assumed to mean that the degree of similarity to the determination business form type is greater than or equal to a predetermined threshold value. Hereinafter, the business form types similar to the determination business form type will be referred to as the “similar business form types”. In the present exemplary embodiment, the determination business form type and the similar business form types are used as an example of the plurality of types which are the candidates of the type of data. Processing of the business form type determination unit 33 is performed as an example of specifying the plurality of types. In addition, in the present exemplary embodiment, the determination business form type is used as an example of the second type among the plurality of types and an example of a type that is determined as having a highest probability of being the type of data. Furthermore, in the present exemplary embodiment, the similar business form types are used as an example of one or more types other than the second type among the plurality of types and an example of the type of which the degree of similarity to the second type is determined as being greater than or equal to the reference.

For example, the business form type determination unit 33 may set business forms having an approximate feature amount of the business form type, that is, business form types of which a degree of approximation to the feature amount of the business form type is within a predetermined range, as the similar business form types. Here, a feature amount related to a content of the business form is considered as the feature amount. For example, a feature related to the content of the business form is a feature amount related to an item included in the business form. For example, an item of an invoice is similar to an item of a bill. Thus, a business form type “invoice” is determined as being similar to a business form type “bill”. In addition, for example, the feature related to the content of the business form is a feature amount related to a layout of the business form. Furthermore, information related to the content of the business form may be at least one of the features. Alternatively, a feature related to an operation performed on the business form is also considered as the feature amount. For example, the feature amount related to the operation performed on the business form is a date on which the business form is transmitted. This feature amount is used in a case where the business form type of the business form can be inferred from the date on which the business form is transmitted. In the present exemplary embodiment, a condition that the feature amount of the business form type is approximate is used as an example of the predetermined condition related to the feature of each type of the plurality of types. Processing of the business form type determination unit 33 is performed as an example of specifying the plurality of types based on whether or not the data satisfies the predetermined condition.

In a case where only the determination business form type is received from the business form type determination unit 33, the attribute extraction unit 34 first reads a target business form image from the business form image storage unit 32. Next, the attribute extraction unit 34 extracts the attribute from the business form image by considering the business form type as the determination business form type. Hereinafter, the attribute extracted from the business form image by considering the business form type as the determination business form type will be referred to as the “attribute with respect to the determination business form type”. Next, the attribute extraction unit 34 stores, in the attribute information storage unit 35, attribute information in which the determination business form type and the attribute with respect to the determination business form type are associated with each other. The attribute extraction unit 34 outputs the determination business form type and the attribute with respect to the determination business form type to the display control unit 36.

In addition, in a case where the determination business form type and the similar business form types are received from the business form type determination unit 33, the attribute extraction unit 34 first reads the target business form image from the business form image storage unit 32. Next, the attribute extraction unit 34 extracts the attribute with respect to the determination business form type from the business form image by considering the business form type as the determination business form type, and extracts attributes from the business form image by considering the business form type as the similar business form types. Hereinafter, the attributes extracted from the business form image by considering the business form type as the similar business form types will be referred to as the “attributes with respect to the similar business form types”. Next, the attribute extraction unit 34 distinctively stores, in the attribute information storage unit 35, the attribute information in which the determination business form type and the attribute with respect to the determination business form type are associated with each other, and the attribute information in which the similar business form types and the attributes with respect to the similar business form type are associated with each other. The attribute extraction unit 34 outputs the determination business form type, the similar business form types, and the attribute with respect to the determination business form type to the display control unit 36. Even in a case where attributes with respect to all similar business form types received from the business form type determination unit 33 are not extracted from the business form image, the attribute extraction unit 34 may output the determination business form type, the similar business form types, and the attribute with respect to the determination business form type to the display control unit 36. In this case, the attributes with respect to the similar business form types extracted from the business form image before the determination business form type, the similar business form type, and the attribute with respect to the determination business form type are output to the display control unit 36 are an example of the at least one type of the plurality of specified types.

Furthermore, in a case where a selection business form type that is a business form type selected by the user is received from the operation reception unit 37, the attribute extraction unit 34 determines whether or not the selection business form type is included in the similar business form types by referring to the attribute information storage unit 35.

In a case where a determination that the selection business form type is not included in the similar business form types is made, the attribute extraction unit 34 reads the target business form image from the business form image storage unit 32 and extracts the attribute from the business form image by considering the business form type as the selection business form type. Hereinafter, the attribute extracted from the business form image by considering the business form type as the selection business form type will be referred to as the “attribute with respect to the selection business form type”. The attribute extraction unit 34 outputs the extracted attribute with respect to the selection business form type to the display control unit 36.

In a case where a determination that the selection business form type is included in the similar business form types is made, the attribute extraction unit 34 acquires the attribute with respect to the selection business form type from the attribute information storage unit 35. The attribute acquired in this manner is also an attribute extracted from the business form image by considering the business form type as the selection business form type. Thus, hereinafter, this attribute will be referred to as the “attribute with respect to the selection business form type”. The attribute extraction unit 34 outputs this acquired attribute with respect to the selection business form type to the display control unit 36.

Here, for example, the attribute may be an item included in the business form. Alternatively, the attribute may be an item in a case of registering the business form in the task management apparatus 40. For example, this item is an item defined in an application for registering the business form in the task management apparatus 40. The item defined in this application is an example of an attribute defined in a service for processing the data. In addition, in the present exemplary embodiment, processing of the attribute extraction unit 34 is performed as an example of acquiring the attribute with respect to the specified type from the data.

The attribute information storage unit 35 stores the attribute information in which the business form type determined by the business form type determination unit 33 and the attribute with respect to the business form type extracted from the business form image by the attribute extraction unit 34 are associated with each other. In this case, the attribute information storage unit 35 distinctively stores the attribute with respect to the determination business form type and the attributes with respect to the similar business form types. Details of the attribute information stored in the attribute information storage unit 35 will be described later.

In a case where the determination business form type and the attribute with respect to the determination business form type are received from the attribute extraction unit 34, the display control unit 36 performs a control for displaying the determination business form type and the attribute with respect to the determination business form type on the display device 25.

In addition, in a case where the determination business form type, the similar business form types, and the attribute with respect to the determination business form type are received from the attribute extraction unit 34, the display control unit 36 performs a control for displaying the determination business form type, the similar business form types, and the attribute with respect to the determination business form type on the display device 25. The display control unit 36 may not initially display the similar business form types on the display device 25, and, for example, perform a control for displaying the similar business form types on the display device 25 in a case where a user operation of requesting a display of selectable similar business form types on the display device 25 is performed. Even in a case where the attributes with respect to all similar business form types specified by the business form type determination unit 33 are not extracted from the business form image, the display control unit 36 may perform a control for displaying the determination business form type, the similar business form types, and the attribute with respect to the determination business form type on the display device 25. In the present exemplary embodiment, this processing of the display control unit 36 is performed as an example of performing the control for displaying the plurality of types after the attribute with respect to the at least one type is acquired from the data. In addition, in the present exemplary embodiment, this processing of the display control unit 36 is performed as an example of performing a control for distinctively displaying the second type and the one or more types other than the second type.

Furthermore, in a case where the attribute with respect to the selection business form type is received from the attribute extraction unit 34, the display control unit 36 performs a control for displaying the attribute with respect to the selection business form type on the display device 25 instead of the attribute with respect to the determination business form type. In the present exemplary embodiment, the selection business form type is used as an example of the first type, and this processing of the display control unit 36 is performed as an example of performing a control for displaying the attribute acquired from the data with respect to the first type in accordance with the operation of selecting the first type by the user. In addition, in the present exemplary embodiment, this processing of the display control unit 36 is performed as an example of performing a control for displaying the attribute acquired from the data with respect to the first type in accordance with an operation of changing the second type to the first type by the user.

In a case where the user performs an operation of selecting one similar business form type from a plurality of similar business form types displayed on the display device 25, the operation reception unit 37 receives the operation and outputs the selection business form type that is the selected similar business form type to the attribute extraction unit 34. In addition, in a case where the user performs an operation of selecting a business form type other than the plurality of similar business form types displayed on the display device 25, the operation reception unit 37 receives the operation and outputs the selection business form type that is the selected business form type to the attribute extraction unit 34. For example, the user performs this operation in a case where a determination that a correct business form type is not present among the plurality of similar business form types displayed on the display device 25 is made. This operation may be performed by displaying, on the display device 25, business form types other than the determination business form type and the similar business form types among business form types defined in the business form processing apparatus 20, and causing the user to select one business form type from the business form types. In the present exemplary embodiment, a user operation of selecting the similar business form type is used as an example of the operation of selecting the first type from the plurality of displayed types by the user. In addition, in the present exemplary embodiment, the user operation of selecting the similar business form type is used as an example of the operation of changing the displayed second type to the first type among the one or more displayed types by the user.

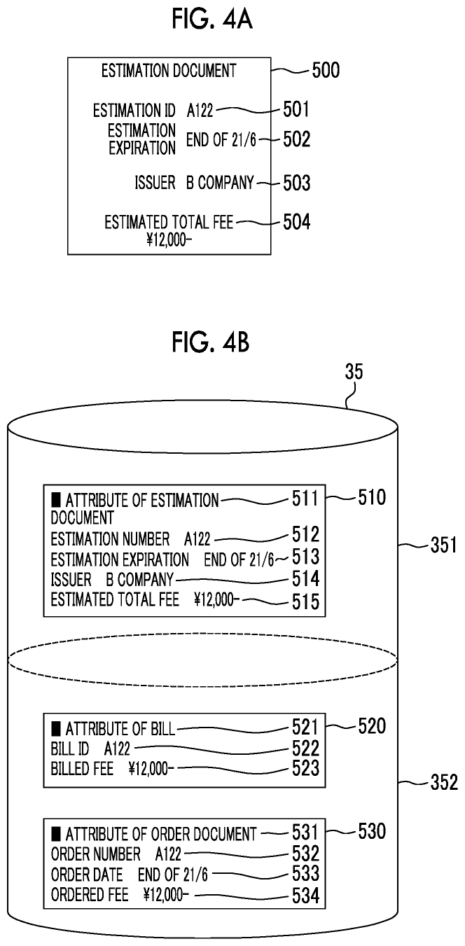

FIGS. 4A and 4B are diagrams for describing the attribute information stored in the attribute information storage unit 35.

FIG. 4A illustrates an example of a business form 500 assumed here. As illustrated in FIG. 4A, the business form 500 includes a description 501 of an estimation ID, a description 502 of estimation expiration, a description 503 of an issuer, and a description 504 of an estimated total fee.

FIG. 4B illustrates storage regions of the attribute information storage unit 35 and the attribute information stored in each storage region of the attribute information storage unit 35. As illustrated in FIG. 4B, the attribute information storage unit 35 is divided into a determination business form type region 351 and a similar business form type region 352.

Here, the business form type determination unit 33 is assumed to determine the business form type of the business form 500 and decide the determination business form type as an estimation document.

Then, the attribute extraction unit 34 extracts the attribute from the business form 500 by considering the business form type as the estimation document and stores the extracted attribute in the determination business form type region 351 of the attribute information storage unit 35 as attribute information 510. The attribute information 510 includes information 511 of the business form type, an attribute 512 of an estimation number, an attribute 513 of the estimation expiration, an attribute 514 of the issuer, and an attribute 515 of the estimated total fee.

In addition, the business form type determination unit 33 is assumed to determine the business form type of the business form 500 and decide the similar business form types as the bill and an order document.

Then, the attribute extraction unit 34 extracts the attribute from the business form 500 by considering the business form type as the bill and stores the extracted attribute in the similar business form type region 352 of the attribute information storage unit 35 as attribute information 520. The attribute information 520 includes information 521 of the business form type, an attribute 522 of a bill ID, and an attribute 523 of a billed fee.

In addition, the attribute extraction unit 34 extracts the attribute from the business form 500 by considering the business form type as the order document and stores the extracted attribute in the similar business form type region 352 of the attribute information storage unit 35 as attribute information 530. The attribute information 530 includes information 531 of the business form type, an attribute 532 of an order number, an attribute 533 of an order date, and an attribute 534 of an ordered fee.

Operation of Business Form Processing Apparatus

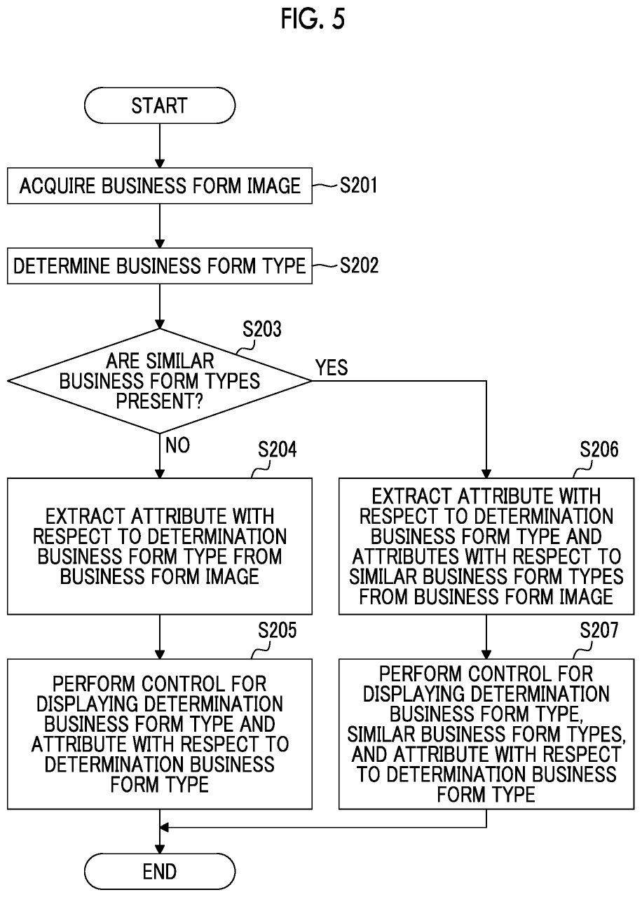

FIG. 5 is a flowchart illustrating an operation example in a case where the business form processing apparatus 20 in the present exemplary embodiment initially displays the business form type and the attribute.

As illustrated in FIG. 5, in the business form processing apparatus 20, first, the business form image acquisition unit 31 acquires the business form image read by the image scanning apparatus 10 (step S201). At this time, the business form image is stored in the business form image storage unit 32.

Next, the business form type determination unit 33 determines the business form type from the business form image acquired in step S201 (step S202). At this time, the business form image is read from the business form image storage unit 32.

Next, the attribute extraction unit 34 determines whether or not the similar business form types are present among business form types determined in step S202 (step S203). Specifically, for example, the attribute extraction unit 34 may determine whether or not the similar business form types are present based on whether the business form type received from the business form type determination unit 33 is only the determination business form type or includes the determination business form type and the similar business form types.

Consequently, in a case where a determination that the similar business form types are not present is made, the attribute extraction unit 34 extracts the attribute with respect to the determination business form type from the business form image acquired in step S201 (step S204). Then, the display control unit 36 performs a control for displaying the determination business form type determined in step S202 and the attribute with respect to the determination business form type extracted in step S204 on the display device 25 (step S205). Accordingly, the determination business form type and the attribute with respect to the determination business form type are displayed on the display device 25.

Meanwhile, in a case where a determination that the similar business form types are present is made, the attribute extraction unit 34 extracts the attribute with respect to the determination business form type and the attributes with respect to the similar business form types from the business form image acquired in step S201 (step S206). Then, the display control unit 36 performs a control for displaying the determination business form type and the similar business form types determined in step S202 and the attribute with respect to the determination business form type extracted in step S206 on the display device 25 (step S207). Accordingly, the determination business form type and the attribute with respect to the determination business form type are displayed on the display device 25. The similar business form types are not initially displayed on the display device 25 and are set to be displayable by a user operation. In this case, even in a case where the attributes with respect to all similar business form types determined in step S202 are not extracted from the business form image in step S206, the display control unit 36 may perform a control for displaying the determination business form type, the similar business form types, and the attribute with respect to the determination business form type on the display device 25.

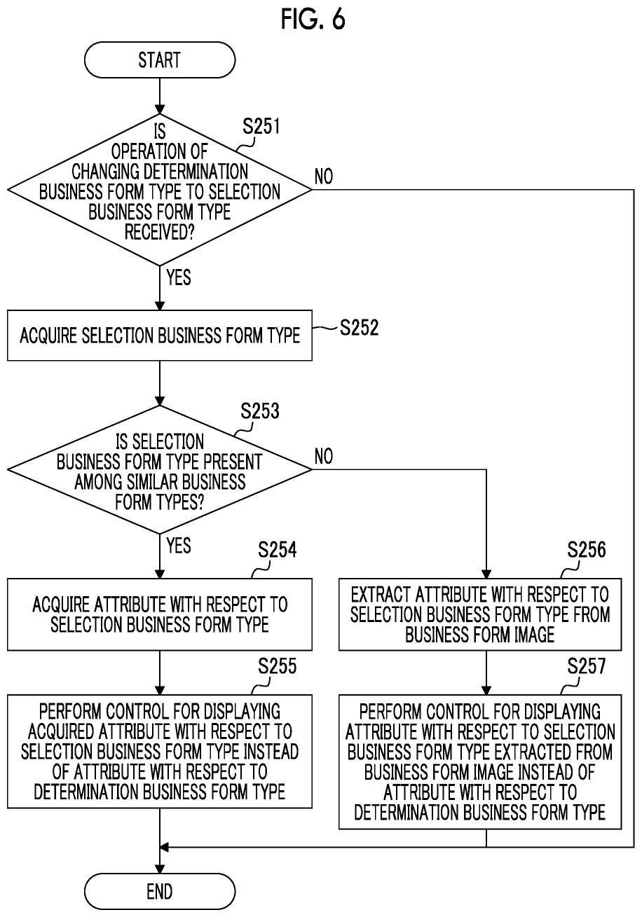

FIG. 6 is a flowchart illustrating an operation example after the business form processing apparatus 20 in the present exemplary embodiment initially displays the business form type and the attribute. Below, a business form type that is not specified as the similar business form types among the business form types defined in the business form processing apparatus 20 is assumed to be also selectable on the display device 25.

As illustrated in FIG. 6, in the business form processing apparatus 20, first, the operation reception unit 37 determines whether or not a user operation of changing the determination business form type to the selection business form type that is the business form type selected as the correct business form type is received on the display device 25 (step S251). Consequently, a case where the operation reception unit 37 determines that the user operation of changing the determination business form type to the selection business form type is not received is a case where the determination business form type displayed in step S205 or step S207 in FIG. 5 is correct. Accordingly, in a case where the attribute with respect to the determination business form type displayed in step S205 or step S207 is also correct, the business form processing apparatus 20 finishes processing. In a case where the attribute with respect to the determination business form type is incorrect, the business form processing apparatus 20 corrects the attribute with respect to the determination business form type in accordance with the user operation and then, finishes processing.

In addition, in a case where the operation reception unit 37 determines that the user operation of changing the determination business form type to the selection business form type is received in step S251, the selection business form type is acquired (step S252). The attribute extraction unit 34 refers to the similar business form type region 352 of the attribute information storage unit 35 and determines whether or not the selection business form type acquired in step S252 is present in the similar business form types (step S253).

Consequently, a determination that the selection business form type is present in the similar business form types is assumed. This determination is made in a case where a similar business form type set to be displayable by the user operation in step S207 in FIG. 5 is selected as the selection business form type. In this case, the attribute extraction unit 34 acquires the attribute with respect to the selection business form type from the similar business form type region 352 of the attribute information storage unit 35 (step S254). Then, the display control unit 36 performs a control for displaying the attribute with respect to the selection business form type acquired in step S254 on the display device 25 instead of the attribute with respect to the determination business form type (step S255). Accordingly, the acquired attribute with respect to the selection business form type is displayed on the display device 25 instead of the attribute with respect to the determination business form type.

Meanwhile, a determination that the selection business form type is not present in the similar business form types is assumed. This determination is made in a case where a business form type that is defined in the business form processing apparatus 20 and is not specified as the similar business form types is selected as the selection business form type. In this case, the attribute extraction unit 34 extracts the attribute with respect to the selection business form type from the business form image stored in the business form image storage unit 32 (step S256). Then, the display control unit 36 performs a control for displaying the attribute with respect to the selection business form type extracted from the business form image in step S256 on the display device 25 instead of the attribute with respect to the determination business form type (step S257). Accordingly, the attribute with respect to the selection business form type extracted from the business form image is displayed on the display device 25 instead of the attribute with respect to the determination business form type.

In the operation examples in FIG. 5 and FIG. 6, the business form processing apparatus 20 narrows down the business form type of the business form to the determination business form type or both of the determination business form type and the similar business form types and extracts the attribute with respect to the narrowed business form type. However, the present invention is not limited thereto.

For example, the business form processing apparatus 20 may cause the user to select real-time processing or batch processing and, in a case where the user selects the batch processing, extract the attributes with respect to all business form types without narrowing down the business form type of the business form. In a case where the user selects the real-time processing, the operations in FIG. 5 and FIG. 6 may be performed.

In addition, in a case where the number of defined types of business form is less than a threshold value, the business form processing apparatus 20 may extract the attributes with respect to all business form types without narrowing down the business form type of the business form. In a case where the number of defined types of business form is greater than or equal to the threshold value, the operations in FIG. 5 and FIG. 6 may be performed.

### Screen Example

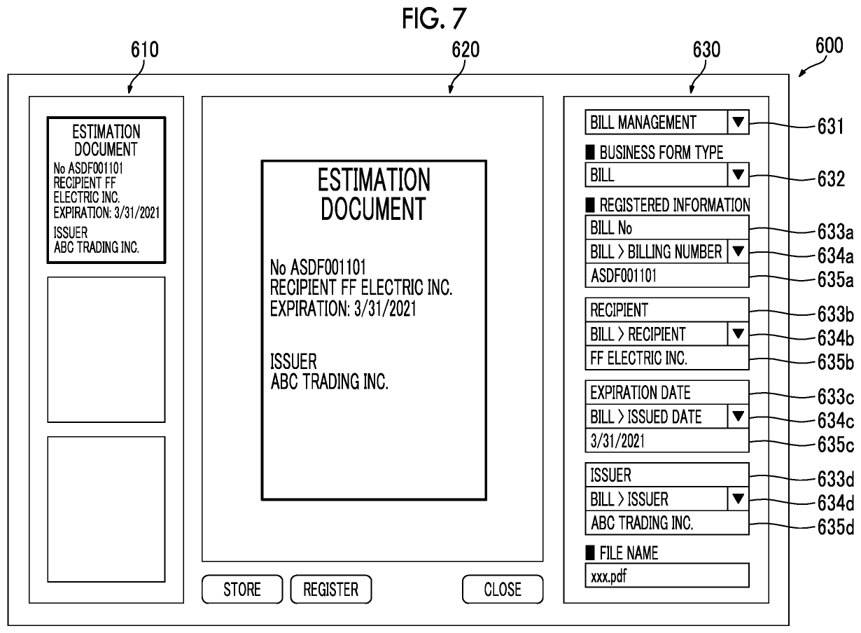

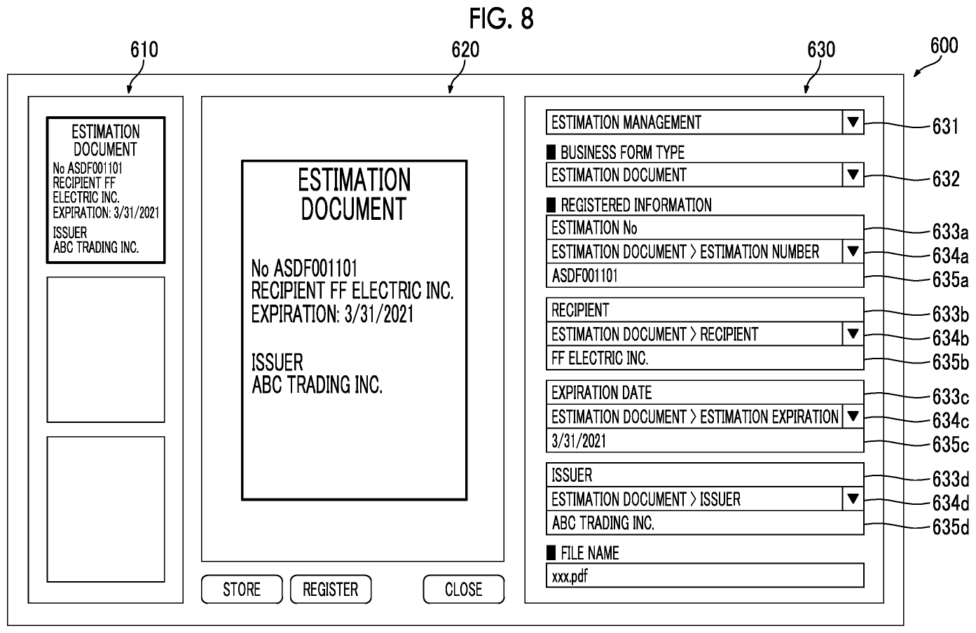

FIG. 7 and FIG. 8 are diagrams illustrating an example of an attribute registration screen 600 for registering the attribute of the business form displayed on the display device 25 by the business form processing apparatus 20 in the task management apparatus 40.

As illustrated in FIG. 7 and FIG. 8, the attribute registration screen 600 includes a reduced image display region 610, an enlarged image display region 620, and a detailed information display region 630. The reduced image display region 610 is a region in which a reduced image of the business form image acquired in step S201 in FIG. 5, that is, a thumbnail image, is displayed. The enlarged image display region 620 is a region in which an enlarged image corresponding to a reduced image selected in the reduced image display region 610 is displayed. The detailed information display region 630 is a region in which detailed information related to the business form is displayed. Here, the detailed information display region 630 includes an application selection field 631 for selecting the application for registering the attribute of the business form in the task management apparatus 40 and a business form type selection field 632 for selecting the business form type of the business form. In addition, the detailed information display region 630 includes registered information display fields 633a to 633d displaying registered information in a case of registering the attribute of the business form in the task management apparatus 40. Furthermore, the detailed information display region 630 includes attribute name selection fields 634a to 634d for selecting an attribute name of the business form and attribute value display regions 635a to 635d displaying attribute values corresponding to attribute names selected in the attribute name selection fields 634a to 634d.

FIG. 7 illustrates an example of the attribute registration screen 600 displayed on the display device 25 in step S207 in FIG. 5. While an image of the estimation document is input as the business form image, the bill is displayed in the business form type selection field 632 as the business form type. Accordingly, “bill No”, “recipient”, “expiration date”, and “issuer” that are registered information with respect to the bill are displayed in the registered information display fields 633a to 633d, respectively. In addition, “billing number”, “recipient”, “issued date”, and “issuer” that are attribute names with respect to the bill are displayed in the attribute name selection fields 634a to 634d, respectively.

FIG. 8 illustrates an example of the attribute registration screen 600 displayed on the display device 25 in step S255 in FIG. 6. In the business form type selection field 632, the estimation document is displayed as the business form type instead of the bill by performing the operation of changing the business form type by the user. Accordingly, “estimation No.”, “recipient”, “expiration date”, and “issuer” that are registered information with respect to the estimation document are displayed in the registered information display fields 633a to 633d, respectively. In addition, “estimation number”, “recipient”, “estimation expiration”, and “issuer” that are attribute names with respect to the estimation document are displayed in the attribute name selection fields 634a to 634d, respectively.

Processor

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

Program

Processing performed by the business form processing apparatus 20 in the present exemplary embodiment is prepared as, for example, a program such as application software.

That is, the program implementing the present exemplary embodiment is perceived as a program causing a computer to implement a function of specifying a plurality of types which are candidates of a type of data, a function of performing a control for displaying the plurality of types after acquiring an attribute with respect to at least one type of the plurality of specified types from the data, and a function of performing a control for displaying the attribute acquired from the data with respect to a first type in accordance with an operation of selecting the first type from the plurality of displayed types by a user.

The program implementing the present exemplary embodiment can be not only provided by communication means but also provided by storing the program in a recording medium such as a CD-ROM.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a processor configured to:
specify a plurality of types which are candidates of a type of data;
perform a control for displaying the plurality of types after acquiring an attribute with respect to at least one type of the plurality of specified types from the data; and
perform a control for displaying the attribute acquired from the data with respect to a first type in accordance with an operation of selecting the first type from the plurality of displayed types by a user.

2. The information processing apparatus according to claim 1, wherein the processor is configured to:
perform a control for distinctively displaying a second type and one or more types other than the second type as the plurality of specified types; and
perform a control for displaying the attribute acquired from the data with respect to the first type in accordance with an operation of changing the displayed second type to the first type among the displayed one or more types by the user.

3. The information processing apparatus according to claim 2,
wherein the second type is a type determined as having a highest probability of being the type of data, and
the one or more types are types of which a degree of similarity to the second type is determined as being greater than or equal to a reference.

4. The information processing apparatus according to claim 1, wherein the processor is configured to:
specify the plurality of types based on whether or not the data satisfies a predetermined condition related to a feature of each type of the plurality of types.

5. The information processing apparatus according to claim 4,
wherein the feature includes a feature related to a content of the data.

6. The information processing apparatus according to claim 5,
wherein the data is business form data, and
the feature related to the content of the data includes at least one of a feature related to an item included in the business form data or a feature related to a layout of the business form data.

7. The information processing apparatus according to claim 4,
wherein the feature includes a feature related to an operation performed on the data.

8. The information processing apparatus according to claim 1, wherein the processor is configured to:
acquire an attribute defined in a service for processing the data from the data as the attribute with respect to the at least one type.

9. A non-transitory computer readable medium storing a program causing a computer to implement:
a function of specifying a plurality of types which are candidates of a type of data;
a function of performing a control for displaying the plurality of types after acquiring an attribute with respect to at least one type of the plurality of specified types from the data; and
a function of performing a control for displaying the attribute acquired from the data with respect to a first type in accordance with an operation of selecting the first type from the plurality of displayed types by a user.

10. An information processing method comprising:
specifying a plurality of types which are candidates of a type of data;
performing a control for displaying the plurality of types after acquiring an attribute with respect to at least one type of the plurality of specified types from the data; and
performing a control for displaying the attribute acquired from the data with respect to a first type in accordance with an operation of selecting the first type from the plurality of displayed types by a user.
